(19) United States
(12) Patent Application Publication
(10) Pub. No.: US 2023/0130241 A1
(43) Pub. Date: Apr. 27, 2023

(54) INTERFACE FOR DYNAMIC MONITORING OF REAL PROPERTY ENVIRONMENTAL CONDITIONS VIA FIXED AND MOBILE SENSOR DEVICES

(71) Applicant: AT&T Intellectual Property I, L.P., Atlanta, GA (US)

(72) Inventors: Ginger Chien, Bellevue, WA (US); Zhi Cui, Sugar Hill, GA (US); Eric Zavesky, Austin, TX (US); Robert T. Moton, JR., Alpharetta, GA (US); Adrianne Binh Luu, Atlanta, GA (US); Robert Koch, Peachtree Corners, GA (US)

(21) Appl. No.: 17/509,867

(22) Filed: Oct. 25, 2021

(51) Int. Cl. G06Q 50/16; G06F 3/0484; G06Q 10/06; G06Q 30/02; G06F 16/9038

(52) U.S. Cl. CPC G06Q 50/16; G06F 3/0484; G06Q 10/06315; G06Q 30/0201; G06F 16/9038

(57) ABSTRACT

A processing system including at least one processor may present via at least one user interface, information associated with a real estate property, receive, via the at least one user interface, a request for data of at least a first data type relating to an environment of the real estate property, identify, from a sensor device database, at least one sensor device that is available for collecting, on or proximate to the real estate property, the data of the at least the first data type, transmit an instruction to the at least one sensor device to collect the data of the at least the first data type, obtain, from the at least one sensor device, the data of the at least the first data type, and present the data of the at least the first data type via the at least one user interface.

The present disclosure relates generally to network-connected sensor devices, and more particularly to methods, computer-readable media, and apparatuses for presenting via at least one user interface data of at least a first data type relating to an environment of a real estate property that is obtained from at least one sensor device in response to a request received via the at least one user interface.

### BACKGROUND

Current trends in wireless technology are leading towards a future where virtually any object can be network enabled and Internet Protocol (IP) addressable. The pervasive presence of wireless networks, including cellular, Wi-Fi, ZigBee, satellite and Bluetooth networks, and the migration to a 128-bit IPv6-based address space provides the tools and resources for the paradigm of the Internet of Things (IoT) to become a reality. In addition, the household use of various sensor devices is increasingly prevalent. These sensor devices may relate to biometric data, environmental data, premises monitoring, and so on.

### SUMMARY

In one example, the present disclosure describes a method, computer-readable medium, and apparatus for presenting via at least one user interface data of at least a first data type relating to an environment of a real estate property that is obtained from at least one sensor device in response to a request received via the at least one user interface. For example, a processing system including at least one processor may present via at least one user interface, information associated with a real estate property, receive, via the at least one user interface, a request for data of at least a first data type relating to an environment of the real estate property, and identify, from a sensor device database, at least one sensor device that is available for collecting, on or proximate to the real estate property, the data of the at least the first data type. The processing system may then transmit an instruction to the at least one sensor device to collect the data of the at least the first data type, obtain, from the at least one sensor device, the data of the at least the first data type, and present the data of the at least the first data type via the at least one user interface.

### BRIEF DESCRIPTION OF THE DRAWINGS

The teachings of the present disclosure can be readily understood by considering the following detailed description in conjunction with the accompanying drawings, in which:

FIG. 1 illustrates an example network related to the present disclosure;

FIG. 2 illustrates user interface examples in accordance with the present disclosure;

FIG. 3 illustrates a flowchart of an example method for presenting via at least one user interface data of at least a first data type relating to an environment of a real estate property that is obtained from at least one sensor device in response to a request received via the at least one user interface; and

FIG. 4 illustrates a high level block diagram of a computing device specifically programmed to perform the steps, functions, blocks and/or operations described herein.

To facilitate understanding, identical reference numerals have been used, where possible, to designate identical elements that are common to the figures.

### DETAILED DESCRIPTION

Examples of the present disclosure provide for methods, computer-readable media, and apparatuses for presenting via at least one user interface data of at least a first data type relating to an environment of a real estate property that is obtained from at least one sensor device in response to a request received via the at least one user interface. For instance, examples of the present disclosure may active or deploy one or more sensors to collect data related to an environment in the vicinity of a piece of real estate (real property). The data may be collected over a period of time and may be used to provide insights about the environment in and around the property that might not otherwise be perceivable by prospective buyers or renters of the property. For example, this may apply to environmental conditions such as noise levels, light levels, air quality levels, radiation levels, and others. These conditions may not be seen or otherwise observed by a potential buyer, for instance in a real estate listing, or even if the buyer visits the property. For instance, the conditions may only occur at certain times of a day or certain times of the year that may different from when the buyer is considering a purchase. For example, the noise level of racing cars emanating from a race track near a neighborhood, the noise level of a church bell that is rung every hour even during night hours near a neighborhood, the noise level of a train whistle that is applied during night hours when the train is passing through a neighborhood and so on. In this regard, examples of the present disclosure collect and provide information regarding environmental conditions that may be persistent or transient related to a property in such a way that potential buyers may be able to use this information to make informed decisions.

In one example, a prospective buyer may wish to conduct a study of a property at a current time and under current condition(s). For instance, the buyer may view an information page associated with a property on a website, an application (app), or the like (broadly a user interface). In accordance with the present disclosure, the interface may present an offer to initiate a collection of environmental data related to the property. In one example, the present disclosure may include a property study database and a sensor database. In requesting the environmental data collection (e.g., a study), information to initiate the study may be obtained from the buyer and/or from a property database, such as location coordinates and/or a street address of the property, a duration of the study, the type(s) of environmental data to be collected (such as lighting level, noise level, etc.), and so forth. In one example, a processing system of the present disclosure may create a record in the property study database indicating the location of the property, the time and date(s), duration, etc. for which the study is to be conducted, the type(s) of data to be collected, and other points of information.

The study record may also include the sensor(s) involved in the data collection. For instance, once the processing system has received the parameters for the study, the processing system may search for available sensors that are located proximate to the property, or that may be deployed on or proximate to the property to conduct the study. In one example, the processing system may search a sensor database for sensors (or “sensor devices”) that are located in the area, e.g., in the vicinity of the property, and that are available to be used for the study for the period of time indicated. The search for available sensors may account for the capabilities each sensor is to have based on the indicated parameters for the study (e.g., capable of collecting the requested type(s) of data, capable of collecting the data over the duration of time indicated (such as having sufficient battery capacity or access to a fixed power source (e.g., the electric power grid, etc.), and so forth). Some sensors in the database may be mobile. In this case, the sensors' availability for participation in the study may depend on current location(s), range(s), abilities to arrive at the location of the study by the time that the study is to be conducted, and so on. In one example, multiple sensors may be selected to participate in the study with regard to a same type of environmental data. For instance, two available sensors that are fixed in a location may be identified as available and one mobile sensor, such as a sensor carried by an autonomous aerial vehicle (AAV), may also be beckoned to participate in the study. In this regard, fixed and mobile sensors may be registered into the sensor database by any numbers of sources, such as municipalities, private citizens, property inspection service providers, and so forth.

In one example, a cost for a study may be presented to the requesting entity (e.g., a prospective buyer of the property) for approval. For instance, sensor owners may indicate a cost for the use of one or more sensors, such as a cost per hour, a cost per day, a cost per study (e.g., with usage not to exceed 48 hours, etc.), and so on. In one example, the processing system may issue commands to one or more fixed sensors to begin monitoring and recording respective environmental data (e.g., to start immediately or at a requested time) for the requested duration of the study. The processing system may further issue a request for one or more mobile sensors to arrive at the location of the study (e.g., on or proximate to the property). In one example, the processing system may further indicate specific areas for the mobile sensor(s) to cover, such as a flight path around the perimeter of the property for an AAV.

Each of the sensors engaged in the study may record the environmental data that it was instructed to record, which may further be provided to the processing system to record in a timestamped entry in the property study database. In various examples, sensors may record data periodically (e.g., sampled data), may record and aggregate data (e.g., 5 minute average, 10 minute average, 5 minute peak sensor reading, 10 minute peak sensor reading, etc.). Alternatively, or in addition, one or more of the sensors may be equipped with continual monitoring capabilities such as ongoing video and audio recording. Thus, in one example, a sensor may make such a recording to be stored in the property study database as well.

The results of the study may be presented to a requester via the user interface in any number of ways. For instance, data from one or more of the sensors may be presented in a graph with indicators of expected, questionable, and unexpected levels of each of the types environmental data measured. For example, the processing system may identify expected, questionable, and unexpected levels based upon averages of sensor data collected from previous studies in a same area, or the like. In one example, the time-stamped sensor data that is presented in graph form may be supplemented by specific audio samples, video samples, or other supplementary data that was collected by the sensor(s), e.g., depending upon the type(s) of data collected. This may be especially useful for a potential buyer to understand any unexpected levels that the sensors may have detected. For instance, if the prospective buyer requests a noise study, a higher than expected audio level in the early hours of the morning may be a cause for concern. Visually, this may be indicated in the graph. However, to better understand the cause, there may be a recorded, time-stamped audio sample associated with this point in time that can be played back to reveal, for instance, a loud barking dog or a loud crowing rooster. The audio sample may be a continuous recording over the study duration that is available. In such case, a requested playback may take the buyer to a time within the audio recording associated with a peak noise level. In another example, the audio sample may be a selection of an audio recording for a specified duration before and after a peak noise level, e.g., a recording of 5 minutes before and 5 minutes after a peak noise level. Likewise, an unexpected level of light, for instance, from tennis courts or a baseball field in a neighborhood park, may also be a factor that the prospective buyer may want to consider. In this case, video or sampled images (broadly “image data”) captured during the sensor readings of the study may be timestamp-associated with a questionable or unexpected light level, and may similarly be presented for review to the buyer. In another example, a study may be conducted over a longer period of time, for instance, for one year, in order to better judge the property under all annual conditions. This approach may permit a prospective buyer to see that during winter months, when the trees are without leaves, the lights from neighboring tennis courts are quite bright in the backyard of the property under consideration. Similarly audio sample playback from the same period of time may also indicate that the noise levels from tennis matches are at higher levels during the fall and winter months.

In one example, the present disclosure may obtain temporal informational data from an external data feed relating to an area including the real estate property (e.g., a Really Simple Syndication (RSS) news feed, or the like). For instance, a processing system may scan sources of data related to events occurring proximate to the location of the study. For instance, an RSS feed of a municipality may announce swimming events taking place during the summer in a nearby pool. The processing system may therefore mark an association between the swimming events and higher than expected noise levels during the season. This may be presented as a potential factor to the buyer. For example, the temporal informational data may be marked in a graph, indexed to at least one corresponding time within the study time period. Likewise, an increase in light level, especially at night time, may be associated with the opening of a new business nearby, e.g., a restaurant with live music, such as identified via a data feed published by a local chamber of commerce or other business associations.

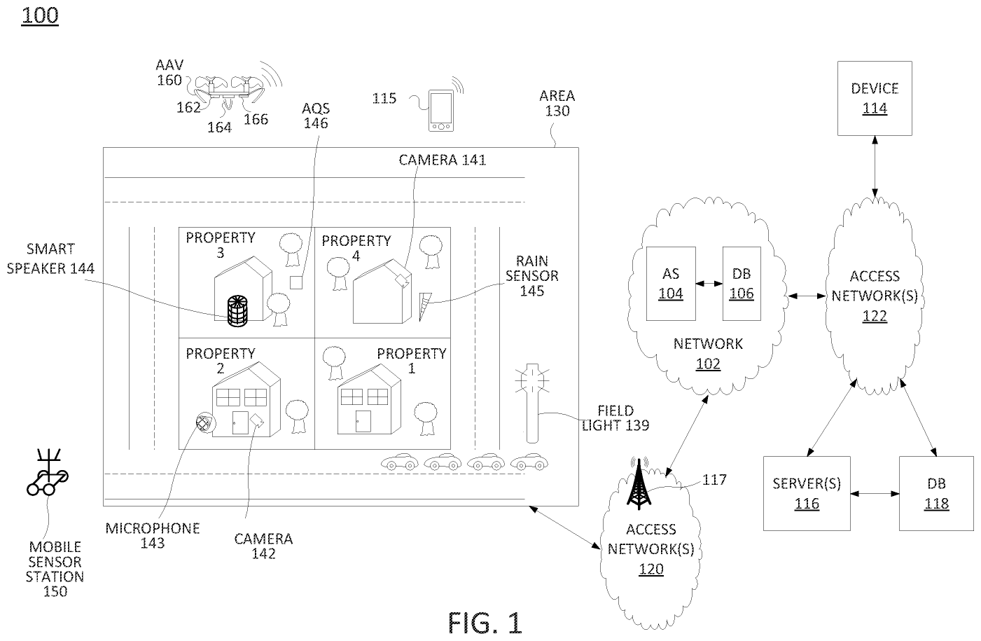

In one example, a study may relate to a number of individual properties in an area. The aggregate results may be used to create a heat map related to one or more of the types of data collected by the sensors. This may provide area-wide information to potential buyers considering a specific area. For instance, in this case, an individual property may be a part of a larger study being conducted over a longer period of time, for instance a citywide study or a neighborhood-wide study. For example, a number of mobile sensors may be used to share the load of collecting all of the sensor data over a period of time. A prospective buyer may also request studies related to other conditions for real estate properties. For example, fixed sensors may be used and/or mobile sensors may deployed to an area to collect image or video records over time. Relative color and darkness levels may be analyzed to determine, for instance how much sunlight versus how much shade covers a zone of the property over time. Thus, a prospective buyer (or a current occupant or owner) may select where to plant and how to maintain crops, vegetation, or decorative flora based upon such a study. Likewise, video analysis of irrigation systems in operation may be used to determine coverage of sprinkler heads. Various other agricultural and landscape applications may be served via the present examples. These and other aspects of the present disclosure are discussed in greater detail below in connection with the examples of FIGS. 1-4.

To further aid in understanding the present disclosure, FIG. 1 illustrates an example system 100 in which examples of the present disclosure for presenting via at least one user interface data of at least a first data type relating to an environment of a real estate property that is obtained from at least one sensor device in response to a request received via the at least one user interface may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, 4G, 5G and the like), a long term evolution (LTE) network, and the like, related to the current disclosure. It should be noted that an IP network is broadly defined as a network that uses Internet Protocol to exchange data packets. Additional example IP networks include Voice over IP (VoIP) networks, Service over IP (SoIP) networks, and the like.

In one example, the system 100 may comprise a network 102, e.g., a core network of a telecommunication network. The network 102 may be in communication with one or more access networks 120 and 122, and the Internet (not shown). In one example, network 102 may combine core network components of a cellular network with components of a triple play service network; where triple-play services include telephone services, Internet services and television services to subscribers. For example, network 102 may functionally comprise a fixed mobile convergence (FMC) network, e.g., an IP Multimedia Subsystem (IMS) network. In addition, network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Network 102 may further comprise a broadcast television network, e.g., a traditional cable provider network or an Internet Protocol Television (IPTV) network, as well as an Internet Service Provider (ISP) network. In one example, network 102 may include a plurality of television (TV) servers (e.g., a broadcast server, a cable head-end), a plurality of content servers, an advertising server (AS), an interactive TV/video-on-demand (VoD) server, and so forth. For ease of illustration, various additional elements of network 102 are omitted from FIG. 1.

In one example, the access networks 120 and 122 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3^{rd} party networks, and the like. For example, the operator of network 102 may provide a cable television service, an IPTV service, or any other types of telecommunication service to subscribers via access networks 120 and 122. In one example, the access networks 120 and 122 may comprise different types of access networks, may comprise the same type of access network, or some access networks may be the same type of access network and other may be different types of access networks. In one example, the network 102 may be operated by a telecommunication network service provider. The network 102 and the access networks 120 and 122 may be operated by different service providers, the same service provider or a combination thereof, or may be operated by entities having core businesses that are not related to telecommunications services, e.g., corporate, governmental or educational institution LANs, and the like. In one example, each of access networks 120 and 122 may include at least one access point, such as a cellular base station, non-cellular wireless access point, a digital subscriber line access multiplexer (DSLAM), a cross-connect box, a serving area interface (SAI), a video-ready access device (VRAD), or the like, for communication with various endpoint devices. For instance, as illustrated in FIG. 1, access network(s) 120 include a wireless access point 117 (e.g., a cellular base station).

In one example, the access networks 120 may be in communication with various devices or computing systems/processing systems, such as mobile device 115, camera 141, camera 142, microphone 143, smart speaker 144, rain sensor 145, air quality sensor (AQS) 146, AAV 160, mobile sensor station 150, and so forth. Similarly, access networks 122 may be in communication with one or more devices, e.g., device 114, server(s) 116, database (DB) 118, etc. Access networks 120 and 122 may transmit and receive communications between mobile device 115, camera 141, camera 142, microphone 143, smart speaker 144, rain sensor 145, air quality sensor (AQS) 146, AAV 160, mobile sensor station 150, device 114, and so forth, and server(s) 116 and/or database (DB) 118, application server (AS) 104 and/or database (DB) 106, other components of network 102, devices reachable via the Internet in general, and so forth.

In one example, device 114 may comprise a mobile device, a cellular smart phone, a laptop, a tablet computer, a desktop computer, a wearable computing device (e.g., a smart watch, a smart pair of eyeglasses, etc.), an application server, a bank or cluster of such devices, or the like. Similarly, mobile device 115 may comprise a cellular smart phone, a laptop, a tablet computer, a wearable computing device (e.g., a smart watch, a smart pair of eyeglasses, etc.), or the like. In accordance with the present disclosure, mobile device 115 may include one or more sensors for tracking location, speed, distance, altitude, or the like (e.g., a Global Positioning System (GPS) unit), for tracking orientation (e.g., gyroscope and compass), and so forth. In addition, mobile device 115 may include one or more sensors for measuring environmental conditions, such as a thermometer, a barometer, a humidity sensor, a decibel meter, a light sensor, a camera and/or a microphone. Cameras 141 and 142 may comprise network-connected home security cameras, such as a door camera, a spotlight camera, a camera mounted on a rooftop eave facing a backyard, etc. Microphone 143, rain sensor 145, and air quality sensor 146 may similarly be network-connected “Internet of Things” (IoT) devices. Likewise, smart speaker 144 may be network-connected and may include sound recording and/or measurement capabilities (e.g., in addition to capabilities for interpreting commands, finding and reporting information, playing music, and so forth).

In accordance with the present disclosure, sensor devices may include mobile sensors. For instance, FIG. 1 illustrates AAV 160 and mobile sensor station 150. In accordance with the present disclosure, AAV 160 may include a camera 162 and one or more radio frequency (RF) transceivers 166 for cellular communications and/or for non-cellular wireless communications. In one example, AAV 160 may also include one or more module(s) 164 with one or more sensors or additional controllable components, such as one or more infrared, ultraviolet, and/or visible spectrum light sources, a light detection and ranging (LiDAR) unit, a radar unit, a microphone, a speaker, and so forth. Mobile sensor station 150 may be similarly equipped with one or more radio frequency (RF) transceivers for cellular communications and/or for non-cellular wireless communications, and one or more sensors, such as one or more cameras or other light sensors, one or more microphones, an air quality sensor, a humidity sensor, a thermometer, a rain sensor, and so forth.

In one example, each of these sensor devices (mobile device 115, camera 141, camera 142, microphone 143, smart speaker 144, rain sensor 145, air quality sensor (AQS) 146, AAV 160, mobile sensor station 150) may communicate independently with access networks 120. In another example, one or more of these sensor devices may comprise a peripheral device that may communicate with remote devices, servers, or the like via access networks 120, network 102, etc. via another endpoint device, such as a smart home hub, a home gateway or router, or the like. Thus, one or more of the camera 141, camera 142, microphone 143, smart speaker 144, etc. may have a wired or wireless connection to another local device that may have a connection to access networks 120.

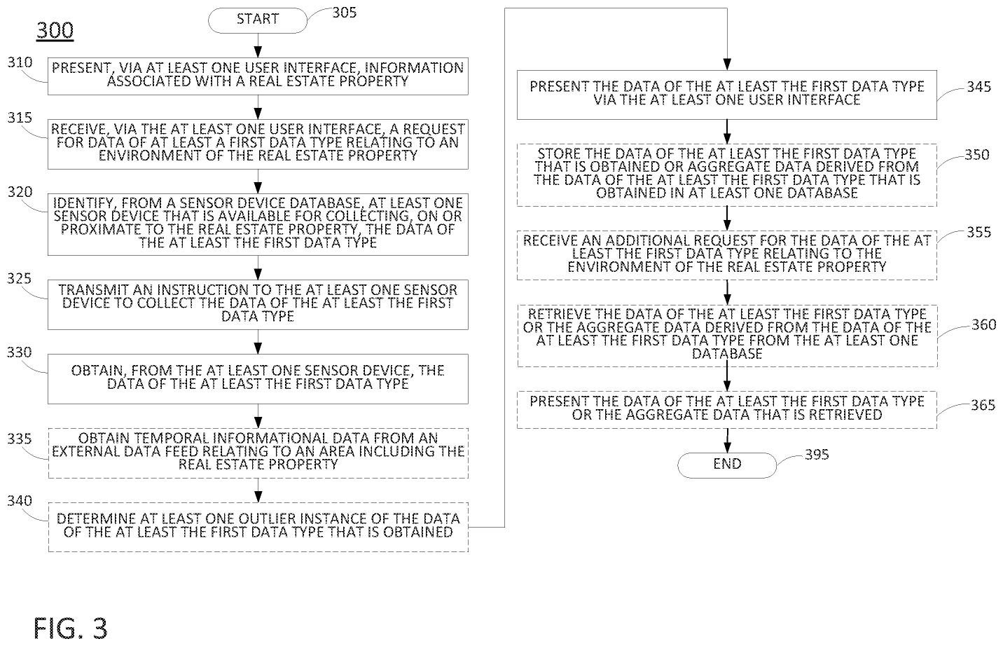

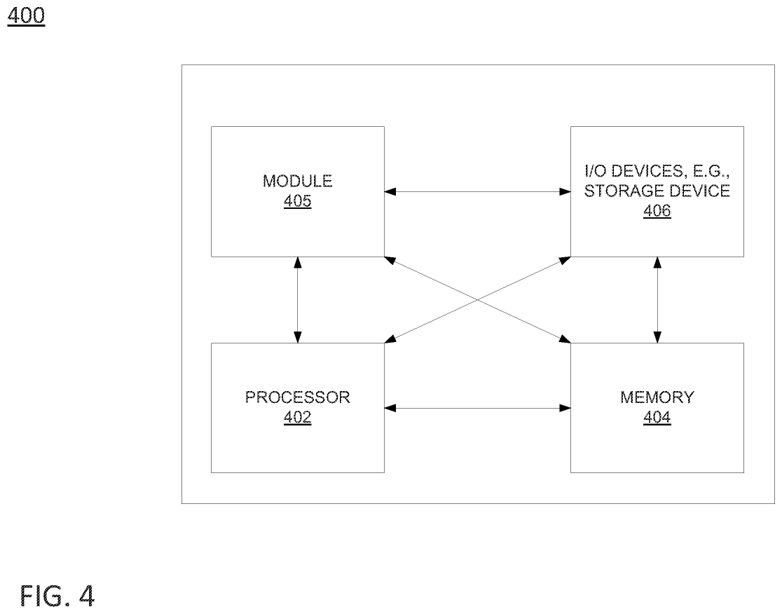

In one example, device 114 may include an application (app) for real estate property information, and which may establish communication with server(s) 116 to access information regarding real estate properties, to request studies, and so forth. For instance, as illustrated in FIG. 1, access networks 122 may be in communication with one or more servers 116 and one or more databases (DB(s)) 118. In accordance with the present disclosure, each of server(s) 116 may comprise a computing system or server, such as computing system 400 depicted in FIG. 4, and may individually or collectively be configured to perform operations or functions for presenting via at least one user interface data of at least a first data type relating to an environment of a real estate property that is obtained from at least one sensor device in response to a request received via the at least one user interface (such as illustrated and described in connection with the example method 300 of FIG. 3). For instance, server(s) 116 may host a real estate information website via which environmental studies may be requested and via which study data may be presented.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

In one example, DB(s) 118 may comprise one or more physical storage devices integrated with server(s) 116 (e.g., a database server), attached or coupled to the server(s) 116, or remotely accessible to server(s) 116 to store various types of information in support of systems for presenting via at least one user interface data of at least a first data type relating to an environment of a real estate property that is obtained from at least one sensor device in response to a request received via the at least one user interface, in accordance with the present disclosure. For example, DB(s) 118 may include a property database that may store information about various properties, such as, for each property: a location of the property, the size of the property, features of any dwelling(s) on the property (such as the floor area, number of bedrooms, number of bathrooms, number of garages, etc.), any pools, decks or patios, annual taxes, homeowners' association dues, community amenities (such as access to a community recreation facility), asking price (if for sale), sales history (such as last sold price and date), estimated/appraised value, and other points of information. In addition, DB(s) 118 may include a sensor database to store a record for each sensor that may include: a sensor identifier (ID), a network address of the sensor, sensor owner information, a sensor type and/or the type(s) of data the sensor is capable of collecting, a fixed location (for a non-mobile sensor), the sensor availability (e.g., dates, data or time ranges, etc.), and for a mobile sensor, the sensor's range, operating time (e.g., without recharging or refueling, etc.), a current location, and so on. In addition, DB(s) 118 may include a study database to store, for each study: a location of the property for which a study is or has been requested, the time and date(s), duration, etc. for which the study is to be conducted, the type(s) of data to be collected, the sensors selected for use or in use (after selection), links to the collected data (e.g., stored in the same database or in a separate database, such as in the sensor database), and other points of information.

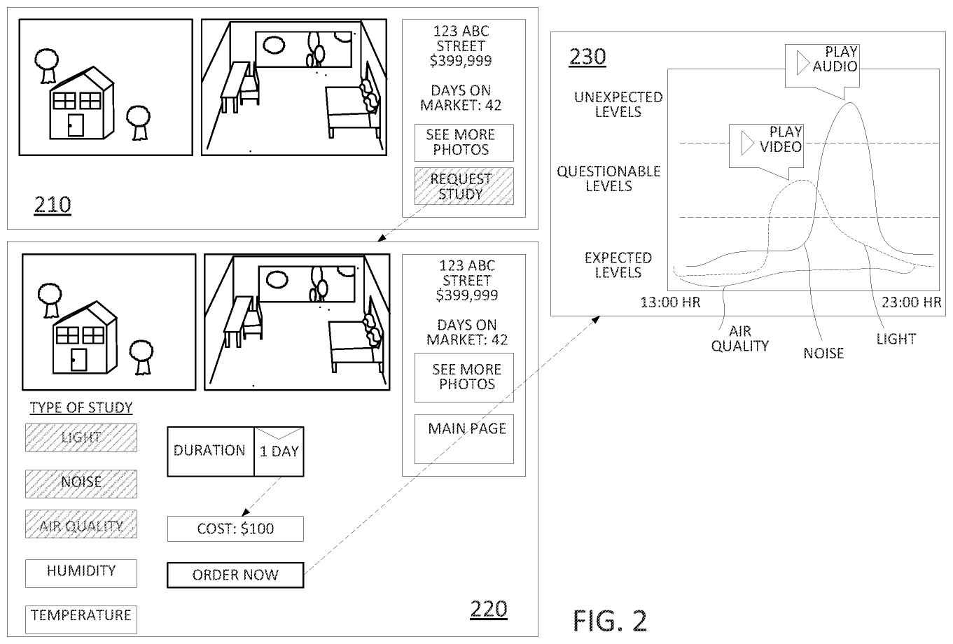

In an illustrative example, Property 1 shown in FIG. 1 may be for sale and a user (e.g., prospective buyer) may seek information regarding Property 1 via device 114. For instance, device 114 may connect to server(s) 116 using an app or via a website associated with a real estate information service provided via server(s) 116. In one example, device 114 may find information regarding Property 1 by searching using an address, or via zooming in and clicking on Property 1 via a map according to a user interface of the app or website. For instance, example user interfaces or user interface screens are illustrated in FIG. 2 and described in greater detail below.

Server(s) 116 may retrieve information regarding Property 1 from a property database of DB(s) 118 and may provide all or a portion of such information to device 114 for presentation to the user. In accordance with the present disclosure, the user interface may include a selectable option, such as a button, a menu item, or the like via which the user may select to initiate a collection of environmental data relating to Property 1. For instance, the user may be interested in purchasing Property 1 and may even have visited Property 1 in-person, but may wish to obtain additional environmental data beyond what might be apparent from only a short visit. For example, the user seek the collection and reporting of light level data, noise level data, humidity data, rain level data, and so forth over a one week period. In one example, server(s) 116 may receive such a request and may create a single study or multiple studies relating to the type(s) of data for which environmental data collection is requested.

In one example, server(s) 116 may access a sensor database of DB(s) 118 to identify available sensors on Property 1 or in the vicinity of Property 1 (e.g., within area 130). In one example, the “vicinity” or “proximate to” may be defined as being within a distance or radius of a property in question, and/or may vary depending upon the type of sensor data. For instance, “proximate to the property” for air quality data (e.g., within ¼ mile) may be a larger zone than “proximate to the property” for light level data (e.g., within 200 feet). In one example, the number of sensors to be use may be selected based upon availability (including other scheduled uses by owners or others), based upon the type of sensor data, based upon cost, and/or based upon the requesting user's preferences, and so on.

Thus, for example, for purposes of measuring light levels, server(s) 116 may identify that cameras 141 and 142 are available and are capable of collecting the requested light level data over the one week time period. As such, server(s) 116 may instruct cameras 141 and 142 to collect such data and/or to record video, capture image samples, or the like, and provide the recorded data to server(s) 116 to determine light level data, e.g., from captured image data, such as taking average pixel intensities over a range of an image, etc. In one example, cameras 141 and 142 may be instructed or requested to orient towards Property 1 for collecting all or a portion of such data. For instance, camera 141 and/or camera 142 may collect 5 minute samples and may orient itself to do so, and may then return to a prior orientation for a primary purpose of the respective device (such as camera 142 functioning as a doorbell camera and providing images from in front of the door of Property 2 for an owner or other occupants of the dwelling on Property 2). Notably, cameras 141 and 142 are not on Property 1. Thus, the prospective buyer may not need permission of the owner of Property 1 to conduct such a study. Rather, the voluntary participation of sensor devices in the vicinity or proximate to Property 1 is obtained by server(s) 116 on behalf of the requesting user of device 114.

As an alternative, or in addition, server(s) 116 may identify that AAV 160 is available and is capable of collecting and reporting light level data over the duration of the study (e.g., for one week), and may instruct AAV 160 to deploy to Property 1. In one example, the prospective buyer/user of device 114 may obtain permission of the owner of Property 1. For instance, the prospective buyer may already have visited Property 1 with a realtor or during an open house and may have a more serious interest in making an offer to buy, or may have already made an offer contingent upon certain environmental conditions being satisfied. In any case, the server(s) 116 may obtain permission for the AAV 160 to enter the air space above Property 1, e.g., continuously over the course of the week. In one example, AAV 160 may not remain in continuous flight above Property 1, but may make short flights to capture sample images, video, and/or other light level data, or data from which light level information may be derived. For instance, AAV 160 may return to a location of an owner of AAV 160 to recharge, replace batteries, etc. With regard to camera 141, camera 142, and AAV 160, in one example, server(s) 116 may record in the study database that these sensor devices have been assigned to the study. In one example, server(s) 116 may also update a sensor database of DB(s) 118 to indicate that these sensor devices are in-use/assigned and are not assignable to other studies for the duration of the existing study as requested by the user of device 114.

In another example, AAV 160 may be instructed by server(s) 116 to deploy to another property or properties near Property 1 (e.g., Property 2, Property 3, and/or Property 4) from which the requested data may be collected. In this case, prior permission is obtained from these owners or other interested parties associated with these properties. Notably, the AAV 160 may be capable of collecting light level data that is better representative of conditions on Property 1 as compared to cameras 141 and 142, even if the AAV 160 may not enter the space above Property 1 directly. For instance, AAV 160 may be capable of capturing data from much closer to the edge of Property 1. In this case, specific permission of an owner of Property 1 may be unnecessary, e.g., if image or video data is not collected such that only light level data is collected (and depending upon local, state, or other laws, rules, or regulations regarding AAVs in effect). The light level data from cameras 141 and 142, and/or AAV 160 may be presented in any number of forms, such as graphs, raw list data (e.g., time stamped readings, per sensor device), summary data (e.g., maximum readings, minimum readings, times of such maximums or minimums, per-hour maximums or minimums, etc.), and so on. Thus, for example, light from field light 139 of a nearby sports field may cause additional night time light to be detected by camera 141, camera 142, and/or AAV 160, which may be revealed in the data collected. In one example, a prospective buyer may not be aware of the times of sunset, sunrise, etc., in a neighborhood. Thus, in one example, server(s) 116 may also provide reference data for comparison along with any results, such as an average of light levels of properties in an entire zip code or other area per hour, average light levels for “dark,” “average,” and “bright” properties, or “rural,” “suburban,” and “urban” properties e.g., as defined by a system operator, or the like, and so on. Similarly, server(s) 116 may use fixed and/or mobile sensors to compare nearby properties to establish whether Property 1 is unusual with respect to more immediate neighbors. For instance, light from field light 139 may have a more significant effect on Property 1, but may be entirely irrelevant to Property 2, for instance. This may be established by collecting light level data from camera 142 on Property 2 and collecting light level data at the same time(s) from AAV 160 deployed over/on Property 1.

Continuing with the example of FIG. 1, the user of device 114 may also have requested noise data collection and reporting regarding Property 1. For instance, the user/prospective buyer may be concerned about noise from a road in front of Property 1. Accordingly, server(s) 116 may search a sensor database of DB(s) 118 to identify that microphone 143 and smart speaker 144 are available and capable of collecting the requested noise data (e.g., audio/sound data) regarding Property 1. It is again noted that these devices are not deployed on Property 1, but are situated nearby and are voluntarily made available (e.g., with specific permission of the owners of these sensors) to participate in collecting and reporting data relating to real estate property environmental conditions. In one example, the user of device 114 may request both outside and inside noise levels be obtained. Thus, for instance, smart speaker 144 may remain deployed within a dwelling of Property 3 and may record sound/audio data over the time period requested. In such case, the smart speaker 144 may continue to provide functions in accordance with its primary purpose, e.g., performing information searches, playing music, and responding to other voice commands, in addition to collecting base noise/sound level data. In another example, an instruction may be transmitted to an owner of the smart speaker 144 to deploy the smart speaker 144 to a protected outside location (e.g., with sufficient time to allow the owner to do so, such as providing notice at least two days in advance). On the other hand, microphone 143 may be part of a smart doorbell system of Property 2 and may be already outside and not readily moveable.

In one example, either or both of the microphone 143 and smart speaker 144 may record audio data (e.g., an audio/sound track or feed, audio/sound samples taken over time periods within successive blocks of time, e.g., 5 second samples every 5 minutes, or the like). In this case, smart speaker 144 may be deployed in an outside location, or the occupant(s) of Property 3 may be away and may give permission for such audio recording as part of the smart speaker 144 being made available for use by server(s) 116. In one example, either or both of the microphone 143 and smart speaker 144 may collect basic sound level data over the study duration, but may record specific audio samples at times of unexpected noise levels, such as those that are excessive for a particular hour as compared to a neighborhood or zip code as determined from noise level data from past studies, or those that are deemed excessive compared to times immediately before and/or after such noise levels are attained. For instance, Property 1 may be typically quiet at the 11 o'clock hour. However, every 15 minutes, a cargo plane may take-off from a nearby airport and may cause noise levels to exceed 70 dB. In this case, the overall nighttime noise level may be relatively low, but may be punctuated by short duration of higher noise level events. The “excessiveness” that may trigger the recording of an actual audio sample may be defined as being 50 percent louder than the average noise level of the prior 5 minutes, for instance, 70 percent louder than the average for the neighborhood at the 11 o'clock hour, and so forth.

The noise/sound level data from microphone 143 and/or smart speaker 144 may be presented in any number of forms, such as graphs, raw list data (e.g., time stamped readings, per sensor device), summary data (e.g., maximum readings, minimum readings, times of such maximums or minimums, per hour maximums or minimums, etc.), and so on. In one example, sound level data may be averaged among microphone 143 and smart speaker 144 and then presented. In one example, server(s) 116 and/or device 114 may cause a graph to be presented with basic noise level data, while links, buttons, or other selectable user interface components may be made available to allow the user to access actual audio samples, such as audio samples from regularly sampled intervals, or those from outlier, e.g., excessive/unusual noise events. Accordingly, in one example, if summary noise data indicates that Property 1 is relatively quiet, but there are a large number of outlier noise events for which samples are made available, this may allow the user to be made aware that vehicular noise is not infrequent (if such is the cause).

FIG. 1 further illustrates that a mobile computing device, such as mobile device 115, may be activated as a sensor device for collecting environmental data associated with a property. For instance, a user of mobile device 115 may be a tenant of Property 4 and may be willing to leave the device plugged in for capturing noise level data for the duration of the study. For example, microphones are ubiquitous for mobile smartphones. In addition, many are equipped with decibel meters or may be outfitted with accurate decibel meter apps. Thus, the user of device 115 may allow device 115 to be used for this purpose (e.g., in exchange for a fee, a credit to be used for studies of other properties that the user of device 115 may be interested in the future, and so forth). As such, noise/sound level data from mobile device 115 may be captured and reported to server(s) 116 in the same or similar manner as described above in connection with microphone 143 and smart speaker 144.

FIG. 1 further illustrates a rain sensor 145 deployed on Property 4, which may be used for collecting rain level data that may be requested by the user of device 114 or others. For instance, many irrigation systems are equipped with rain sensors that may detect whether it has rained recently (and how much rain). For example, an irrigation system of Property 4 may have a watering schedule for watering three times per week in the month of August. However, if it has rained recently (such as may be determined via rain sensor 145), the irrigation system may automatically skip or postpone a scheduled watering. Thus, an owner of Property 4 may make rain sensor 145 available for collecting and providing rain data to server(s) 116 in connection with requests for rain data (e.g., relating to Property 1 or others in the area 130, for example). Similarly, air quality sensor 146 may be deployed on Property 3 and may be for detecting particulate matter (PM), smog, olfactory molecules, and so forth. An owner of Property 3 may therefore make air quality sensor 146 available to server(s) 116 (e.g., in exchange for a fee, a credit to be used for studies of other properties that the owner of Property 3 may be interested in the future, and so forth).

In addition, mobile sensor station 150 is illustrated in FIG. 1 and demonstrates that other autonomous vehicles may be deployed for the purpose of collecting various types of environmental data relating to a property. For instance, mobile sensor station 150 may be dispatched in the same or similar manner as AAV 160 discussed above. For example, mobile sensor station 150 may be dispatched to Property 1, or to a nearby property for which consent has been pre-established or which may be established between the time the request is submitted and the requested start time of the study. Mobile sensor station 150 may include one or multiple sensors, such as one or more cameras or light sensors, one or more microphones or decibel meters, an air quality sensor, a humidity sensor, and so forth. It should also be noted that the foregoing are just several examples of presenting via at least one user interface data of at least a first data type relating to an environment of a real estate property that is obtained from at least one sensor device in response to a request received via the at least one user interface, and that other, further, and different examples may be established in connection with the example of FIG. 1.

It should again be noted that any number of server(s) 116 or database(s) 118 may be deployed. In one example, network 102 may also include an application server (AS) 104 and a database (DB) 106. In one example, AS 104 may perform the same or similar functions as server(s) 116. Similarly, DB 106 may store the same or similar information as DB(s) 118 (e.g., a property database, a sensor database, a study database, etc.). For instance, network 102 may provide a service to subscribing websites and/or user devices in connection with a real estate information service, e.g., in addition to television, phone, and/or other telecommunication services. In one example, AS 104, DB 106, server(s) 116, and/or DB(s) 118, or any one or more of such devices in conjunction with one or more of: mobile device 115, camera 141, camera 142, microphone 143, smart speaker 144, rain sensor 145, air quality sensor (AQS) 146, AAV 160, mobile sensor station 150, device 114, and so forth, may operate in a distributed and/or coordinated manner to perform various steps, functions, and/or operations described herein.

It should be noted that the system 100 has been simplified. Thus, the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, a content distribution network (CDN) and the like. For example, portions of network 102 and/or access networks 120 and 122 may comprise a content distribution network (CDN) having ingest servers, edge servers, and the like, for packet-based streaming of videos or video segments that may be provided in accordance with the present disclosure. Similarly, although only two access networks 120 and 122 are shown, in other examples, access networks 120 and/or 122 may each comprise a plurality of different access networks that may interface with network 102 independently or in a chained manner. For example, device 114 and server(s) 116 may be in communication with network 102 via different access networks, cameras 141 and 142 may be in communication with network 102 via different access networks, mobile sensor station 150 and AAV 160 may be in communication with network 102 via different access networks and so forth. Thus, these and other modifications are all contemplated within the scope of the present disclosure.

To further aid in understanding the present disclosure, FIG. 2 illustrates example screens of a user interface of a real property information service, in accordance with the present disclosure. For instance, example screens 210, 220, and 230 may be presented via a website or app for such a real property information service. In a first example screen 210, a real estate listing page may present images/photographs of a property, property information, such as an address, listing price, number of days on the market, and so forth. In addition, the first example screen 210 may also include buttons to “see more photos” and to “request study.” For instance, the buttons may be selectable by pointing and clicking with a mouse or touchscreen of a device via which the real property information service is accessed. In this example, a user may select “request study,” which may cause the loading of the second example screen 220.

The second example screen 220 may present some of the same information as the first example screen 210, such as images of the property, property information, and so forth. The second example screen 220 may also include buttons to “see more photos” and to return to the “main page” (e.g., the first example screen 210). In addition, the second example screen 220 may include user interface elements for ordering a study, e.g., the collection of environmental data relating to the property. For instance, the second example screen 220 may include buttons to select a type of study (e.g., one or more types of environmental data to be collected), and a drop-down menu to select the duration of the study. As illustrated in FIG. 2, the second example screen 220 may also include an interface element to present a cost or an estimated cost of the study. For example, a processing system of the present disclosure, such as server(s) 116 of FIG. 1 or the like, may calculate the cost based upon the type(s) of environmental data selected and the duration selected. For instance, the processing system may scan a sensor database to identify available sensors and the cost of the use of the sensors for the type(s) of environmental data being requested. In this case, the user may have selected to have noise data, light level data, and air quality data collected over the course of one day. In addition, for illustrative purposes, it may be assumed that the user has clicked an “order now” button after viewing the cost and finding the cost acceptable. In one embodiment, a portion of the cost may include paying the owner of the listed property to allow such study to be conducted on the owner's listed property.

After selecting “order now,” one or more additional screens may be presented, such as a screen to enter payment details, a screen to confirm the order, etc. In one example, a viewing device may return to the first example screen 210 to allow the user to continue to consider details of the property, such as selecting the button to “see more photos,” which may cause yet another screen to load with one or more additional images/photographs, and so forth. It should be noted that since the study is to take place over at least a one day time period, the user may exit the app or leave the website for some time. However, since the user has requested the study and is therefore interested in the results, the user may again open the app or navigate to the website in order to view such results. Thus, for instance, the user may return to the first example screen 210 or a similar screen which may include a button to “view results” (not shown), which may cause the third example screen 230 to be loaded. Alternatively, or in addition, if the user provides login details via the website or has consented for the website or app to remain logged in, the user may be automatically taken to the third example screen 230 if the study/data collection is completed at the time of the user's return to the website or app.

In any case, the third example screen 230 may present the results of the study in a graph form. As noted above, in one example, the present disclosure may present the sensor data results with indications of “expected levels,” “questionable levels,” and “unexpected levels” indicated (where these levels may be pre-determined in a number of ways, such as by averaging over prior readings within the same neighborhood, zip code, or other areas, and so on). For instance, “unexpected levels” may comprise readings at a 90^{th} percentile and above (e.g., per the zip code, neighborhood, etc.), the questionable levels may comprise the 70^{th}-90^{th} percentile readings, and so on. It should be noted that although the study was for an entire day, in one example, the graph may present a shorter time period, such as a 10 hour time block as illustrated in FIG. 2. However, if the user wishes to view additional times, in one example, the user may click in the graph and drag to the left or right to show earlier or later times, may click and scroll to change the scale of the graph to include more or less time, etc. Similarly, if the user is using a tablet computing device or smartphone with a touchscreen, the user may touch the screen on the graph with two fingers and pinch or spread to achieve a similar effect, for instance.

As illustrated in FIG. 2, the third example screen 230 also includes dialog boxes and buttons to “play audio” and “play video.” For instance, as noted above, in one example, the present disclosure may record samples for certain types of sensor data, such as an audio sample and/or video sample representative of outliers in the data collected. For instance, in this case, there may a video sample for the peak light level data. It should be noted that the “peak light level data” in one example is not necessarily the brightest time of day, but may be the most divergent from what is expected, or what is average in the neighborhood, zip code, or other areas, e.g., for a given hour of the day, for a given 30 minute block of the day, etc. Thus, in the graph, the light at 6:00 PM (e.g., the 18:00 hour) is indicated to be at a questionable level, which may indicate that lights from a nearby sports field or tennis courts are turned on and affecting the property (e.g., as determined by the sensor(s) at the sensor location(s)), whereas it may be expected to be darker based upon light level data previously collected for studies of other properties in the neighborhood, zip code, etc. for the time of year, or similar data otherwise collected. As such, the user may access a video sample representing this outlier by clicking the “play video” button/dialog box in the graph of the third example screen 230. Similarly, the noise level data indicates that an “unexpected” level was reached around 9:00 PM (21:00 hour) as shown in the graph of the third example screen 230. For instance, there may be a local pickup basketball game for adults taking place on a nearby court such that there is road traffic coming and going past the property around this time or for which the sounds of the game may be heard on or near the property. In this case, the user may hear an audio sample that was recorded by selecting the “play audio” button/dialog box as shown on the graph of the third example screen 230.

It should be noted that the foregoing are merely several example screens of a user interface that may be presented in accordance with the present disclosure, and that other, further, and different example screens and/or user interface(s) may be utilized in various designs. As just one additional example, a user may view a property via an augmented reality (AR) headset when physically present at the property or via a virtual reality (VR) headset from any location, wherein the headset or associated computing device may access and present AR and/or VR content relating to the property, such as some or all of the same information shown in the first example screen 210, e.g., the address, the list price, the number of days on the market, etc. In such an example, a user may request a study by being presented with such an option as AR and/or VR content and by speaking a command, such as “request study.” In addition, the results, e.g., the sensor data collected may be presented in alternative or additional forms, such as a list of time-stamped entries, a graph of raw values, a graph of percentile values (e.g., compared to an average for the sensor data collected for the property itself, or compared to other properties in a neighborhood, zip code, or other areas, etc.), a map of sensor locations and color coding of the sensor reading levels at a given time, and so on. Thus, these and other modifications are all contemplated within the scope of the present disclosure.

FIG. 3 illustrates a flowchart of an example method 300 for presenting via at least one user interface data of at least a first data type relating to an environment of a real estate property that is obtained from at least one sensor device in response to a request received via the at least one user interface, in accordance with the present disclosure. In one example, the method 300 is performed by a component of the system 100 of FIG. 1, such as by server(s) 116, application server 104, and/or any one or more components thereof (e.g., a processor, or processors, performing operations stored in and loaded from a memory), by server(s) 116 and/or application server 104 in conjunction with one or more other devices, such as DB 106, DB(s) 118, or any of the sensor devices of FIG. 1, and so forth. In one example, the steps, functions, or operations of method 300 may be performed by a computing device or system 400, and/or processor 402 as described in connection with FIG. 4 below. For instance, the computing device or system 400 may represent any one or more components of a device, server, and/or application server in FIG. 1 that is/are configured to perform the steps, functions and/or operations of the method 300. Similarly, in one example, the steps, functions, or operations of method 300 may be performed by a processing system comprising one or more computing devices collectively configured to perform various steps, functions, and/or operations of the method 300. For instance, multiple instances of the computing device or processing system 400 may collectively function as a processing system. For illustrative purposes, the method 300 is described in greater detail below in connection with an example performed by a processing system. The method 300 begins in step 305 and proceeds to step 310.

At step 310, the processing system presents, via at least one user interface, at least one information page comprising information associated with a real estate property. The at least one user interface may comprise, for example, a website or a device application (app). For instance, an example user interface (e.g., representative screens/pages thereof) is illustrate in FIG. 2.

At step 315, the processing system receives, via the at least one user interface, a request for data of at least a first data type relating to an environment of the real estate property. The data of the at least the first data type may comprise for example, sound data (or “noise data”), light data (or “light level data”), air quality data, humidity data, temperature data, and so forth. In one example, the request may include a duration of time for collecting the data of the at least the first data type relating to the environment of the real estate property, such as one day, two days, one week, two weeks, and so forth. In one example, the at least the first data type may comprise at least two data types, the at least two data types including at least a second data type.

At step 320, the processing system identifies, from a sensor device database, at least one sensor device that is available for collecting, on or proximate to the real estate property, the data of the at least the first data type. The at least one sensor device may comprise a mobile sensor device or may be deployed on at least one other real estate property proximate to the real estate property (e.g., a fixed-location sensor device). In one example, the at least the first data type comprises at least two data types, the at least two data types including at least a second data type. In such case, step 320 may include identifying at least a second sensor device proximate to the real estate property that is available for collecting data of a second data type.

At step 325, the processing system transmits an instruction to the at least one sensor device to collect the data of the at least the first data type. In one example, the at least the first data type comprises at least two data types, the at least two data types including at least a second data type. In such case, step 325 may include transmitting a second instruction to the at least the second sensor device that may be identified at step 320 to collect data of the at least the second data type. In an example in which the at least one sensor device comprises a mobile sensor device, the instruction transmitted at step 325 may include an instruction for the at least one sensor device to deploy to a location on or proximate to the real estate property.

At step 330, the processing system obtains, from the at least one sensor device, the data of the at least the first data type. In an example in which the at least the first data type includes at least a second data type, step 330 may include obtaining, from the at least the second sensor device, the data of the at least the second data type.

At optional step 335, the processing system may obtain temporal informational data from an external data feed relating to an area including the real estate property. For example, an external data feed may comprise an RSS feed or the like from a municipality, a chamber of commerce, etc., and may indicate one or more events taking place in a relevant area, the times of such events, and so forth.

At optional step 340, the processing system may determine at least one outlier instance of the data of the at least the first data type that is obtained. For example, the at least one outlier instance may comprise an excessive sound level, an excessive light level, and so on, where “excessive” may be defined as above (or below) a threshold level as compared to the same type of sensor data for a neighborhood or zip code (and for the same time of day and/or day of the week, etc.) as determined from past studies, or above or below a threshold differential or percentage as compared to times immediately before and/or after for the same sensor data from the same sensor, and so on.

At step 345, the processing system, presents the data of the at least the first data type via the at least one user interface. In an example in which the at least the first data type includes at least a second data type, step 345 may include presenting the data of the at least the second data type via the at least one user interface. In one example, step 345 may comprise presenting a graph of the data of the at least the first data type that is obtained. For instance, the graph may display the data of the at least the first data type over a duration of time for which the study was requested at step 315. In one example, the graph may display temporal informational data indexed to at least one corresponding time within the duration of time (e.g., in an example, in which temporal information data may be collected at optional step 335). For instance, the graph may include a marker of a time at which an event is determined from the temporal information data (e.g., a scheduled evening football game at a nearby school field, etc.). Alternatively, or in addition, step 345 may include presenting the data of the at least the first data type via a map, e.g., where the map may indicate a location of the at least one sensor from which the data of the at least the first data type was obtained. In one example, step 345 may include presenting a sample data of at least one outlier instance that may be determined at optional step 340. For instance, the sample data of the at least one outlier instance may comprise an audio sample or an image/video sample.

At optional step 350, the processing system may store the data of the at least the first data type that is obtained (such as raw timestamped sensor data) or aggregate data derived from the data of the at least the first data type that is obtained (e.g., a graph, data summarized in 5 minute or 10 minute averages, etc.) in at least one database.

At optional step 355, the processing system may receive an additional request for the data of the at least the first data type relating to the environment of the real estate property. For instance, a different user may access a real estate information service provided via the processing system via a respective user interface and may request the data of the at least the first data type in the same or similar manner as described above in connection with step 315.

At optional step 360, the processing system may retrieve the data of the at least the first data type or the aggregate data derived from the data of the at least the first data type from the at least one database. For instance, since the requested data has already been collected via a previous study, the processing system may not repeat the study but may simply present the previously stored results.

At optional step 365, the processing system may present the data of the at least the first data type or the aggregate data that is retrieved. For instance, optional step 365 may comprise the same or similar operations as described above in connection with step 345.

Following step 345 or any one of optional steps 350-365, the method 300 proceeds to step 395 where the method ends.

It should be noted that the method 300 may be expanded to include additional steps, or may be modified to replace steps with different steps, to combine steps, to omit steps, to perform steps in a different order, and so forth. For instance, in one example the processor may repeat one or more steps of the method 300 for different studies relating to the same or a different property. In one example, the method 300 may also include registering sensors into the sensor database, accessing property data from a property database prior to step 310, and so forth. In one example, the method 300 may include allowing a subsequent user the choice of having a new study conducted or accessing previously stored results for the same type of sensor data relating to a property. Alternatively, or in addition, the method 300 may include presenting the user with a list and/or map of sensor device(s) and or their location(s) anticipated to be used, and allowing the user to accept or reject the initiation of the study. For example, a user may be dissatisfied that the closest microphone for a noise study is more than three properties away from the property in question and may cancel the request. In one example, the method 300 may be expanded or modified to include steps, functions, and/or operations, or other features described above in connection with the example(s) of FIGS. 1 and 2, or as described elsewhere herein. Thus, these and other modifications are all contemplated within the scope of the present disclosure.

In addition, although not expressly specified above, one or more steps of the method 300 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 3 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the example embodiments of the present disclosure.

FIG. 4 depicts a high-level block diagram of a computing device or processing system specifically programmed to perform the functions described herein. For example, any one or more components or devices illustrated in FIG. 1 or described in connection with the examples of FIG. 2 or 3 may be implemented as the processing system 400. As depicted in FIG. 4, the processing system 400 comprises one or more hardware processor elements 402 (e.g., a microprocessor, a central processing unit (CPU) and the like), a memory 404, (e.g., random access memory (RAM), read only memory (ROM), a disk drive, an optical drive, a magnetic drive, and/or a Universal Serial Bus (USB) drive), a module 405 for presenting via at least one user interface data of at least a first data type relating to an environment of a real estate property that is obtained from at least one sensor device in response to a request received via the at least one user interface, and various input/output devices 406, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the computing device may employ a plurality of processor elements. Furthermore, although only one computing device is shown in the Figure, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of this Figure is intended to represent each of those multiple general-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for presenting via at least one user interface data of at least a first data type relating to an environment of a real estate property that is obtained from at least one sensor device in response to a request received via the at least one user interface (e.g., a software program comprising computer-executable instructions) can be loaded into memory 404 and executed by hardware processor element 402 to implement the steps, functions or operations as discussed above in connection with the example method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for presenting via at least one user interface data of at least a first data type relating to an environment of a real estate property that is obtained from at least one sensor device in response to a request received via the at least one user interface (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
presenting, by a processing system including at least one processor via at least one user interface, information associated with a real estate property;
receiving, by the processing system, via the at least one user interface, a request for data of at least a first data type relating to an environment of the real estate property;
identifying, by the processing system, from a sensor device database, at least one sensor device that is available for collecting, on or proximate to the real estate property, the data of the at least the first data type;
transmitting, by the processing system, an instruction to the at least one sensor device to collect the data of the at least the first data type;
obtaining, by the processing system from the at least one sensor device, the data of the at least the first data type; and
presenting, by the processing system, the data of the at least the first data type via the at least one user interface.

2. The method of claim 1, wherein the at least the first data type comprises at least two data types, the at least two data types including at least a second data type.

3. The method of claim 2, wherein the identifying includes identify at least a second sensor device proximate to the real estate property that is available for collecting data of the at least the second data type, and wherein the transmitting includes transmitting a second instruction to the at least the second sensor device to collect data of the at least the second data type.

4. The method of claim 3, wherein the obtaining includes obtaining, from the at least the second sensor device, the data of the at least the second data type, and wherein the presenting includes presenting the data of the at least the second data type via the at least one user interface.

5. The method of claim 1, wherein the at least one sensor device comprises a mobile sensor device, wherein the instruction includes an instruction for the at least one sensor device to deploy to a location on or proximate to the real estate property.

6. The method of claim 1, wherein the at least one sensor device is deployed on at least one other real estate property proximate to the real estate property.

7. The method of claim 1, wherein the request includes a duration of time for collecting the data of the at least the first data type relating to the environment of the real estate property.

8. The method of claim 7, wherein the presenting includes presenting a graph of the data of the at least the first data type that is obtained.

9. The method of claim 8, wherein the graph displays the data of the at least the first data type over the duration of time.

10. The method of claim 9, further comprising:
obtaining temporal informational data from an external data feed relating to an area including the real estate property, wherein the graph displays the temporal informational data indexed to at least one corresponding time within the duration of time.

11. The method of claim 1, wherein the presenting includes presenting the data of the at least the first data type via a map, wherein the map indicates a location of the at least one sensor from which the data of the at least the first data type is obtained.

12. The method of claim 1, further comprising:
determining at least one outlier instance of the data of the at least the first data type that is obtained, wherein the presenting includes presenting a sample data of the at least one outlier instance.

13. The method of claim 12, wherein the sample data of the at least one outlier instance comprises an audio sample, an image sample or a video sample.

14. The method of claim 13, wherein the at least one outlier instance comprises an excessive sound level or an excessive light level.

15. The method of claim 1, wherein the data of the at least the first data type comprises:
sound data;
light data;
air quality data;
humidity data; or
temperature data.

16. The method of claim 1, further comprising:
storing the data of the at least the first data type that is obtained or aggregate data derived from the data of the at least the first data type that is obtained in at least one database.

17. The method of claim 16, further comprising:
receiving an additional request for the data of the at least the first data type relating to the environment of the real estate property;
retrieving the data of the at least the first data type or the aggregate data derived from the data of the at least the first data type from the at least one database; and
presenting the data of the at least the first data type or the aggregate data that is retrieved.

18. The method of claim 1, wherein the at least one user interface comprises:
a website; or
a device application.

19. A non-transitory computer-readable medium storing instructions which, when executed by a processing system including at least one processor, cause the processing system to perform operations, the operations comprising:
presenting, via at least one user interface, information associated with a real estate property;
receiving, via the at least one user interface, a request for data of at least a first data type relating to an environment of the real estate property;
identifying, from a sensor device database, at least one sensor device that is available for collecting, on or proximate to the real estate property, the data of the at least the first data type;
transmitting an instruction to the at least one sensor device to collect the data of the at least the first data type;
obtaining, from the at least one sensor device, the data of the at least the first data type; and
presenting the data of the at least the first data type via the at least one user interface.

20. An apparatus comprising:
a processing system including at least one processor; and
a computer-readable medium storing instructions which, when executed by the processing system, cause the processing system to perform operations, the operations comprising:
presenting, via at least one user interface, information associated with a real estate property;
receiving, via the at least one user interface, a request for data of at least a first data type relating to an environment of the real estate property;
identifying, from a sensor device database, at least one sensor device that is available for collecting, on or proximate to the real estate property, the data of the at least the first data type;
transmitting an instruction to the at least one sensor device to collect the data of the at least the first data type;
obtaining, from the at least one sensor device, the data of the at least the first data type; and
presenting the data of the at least the first data type via the at least one user interface.
